(19) United States
(12) Patent Application Publication
(10) Pub. No.: US 2002/0067363 A1
(43) Pub. Date: Jun. 6, 2002

(54) Animation generating method and device, and medium for providing program

(76) Inventors: Yasunori Ohto, Tokyo (JP); Yuichi Ueda, Tokyo (JP); Takashi Nozaki, Tokyo (JP); Yoichiro Serita, Tokyo (JP)

Correspondence Address: BELL, BOYD & LLOYD, LLC, P. O. BOX 1135, CHICAGO, IL, 60690-1135, US

(21) Appl. No.: 09/946,415

(22) Filed: Sep. 4, 2001

(30) Foreign Application Priority Data
Sep. 4, 2000 (JP) P2000-266926

(51) Int. Cl. G06T 13/00; G06T 15/70

(52) U.S. Cl. 345/474

(57) ABSTRACT

An animation generating unit supplies start requests for entire animation and synthesizing requests for partial animation to an interpolating computation unit, based on input events. The interpolating computation unit extracts the entire animation data and partial animation data from the entire animation storing unit and the partial animation storing unit, respectively, sequentially executes interpolation computation under timer output, generates new animation data, and outputs the newly-generated animation data to an animation display unit. Thus, animation can be efficiently generated.

### BACKGROUND OF THE INVENTION

1. Field of the Invention

The present invention relates to a technique wherein, in the generation of two-dimensional or three-dimensional formed animation data, animation of an entire model is generated by synthesizing animation of various parts of the model. This technique is used at the time the animation is created, and may be used to create animation for games, movie content, and the like.

2. Description of the Related Art

Conventionally, animation of various parts of a model are synthesized. Heretofore, such synthesizing has been performed with parts of the model which have little effect one upon the other, for example, synthesizing the animation of the upper half of a person with the animation of the lower half. Such animation synthesizing work is routinely performed in movie production and the like. However, in the field of real-time animation generating, the quality and time related restrictions are so great, that this type of animation synthesis is not widely used at the present time.

The present inventor has carefully studied the effective generation of various types of animation using partial animation, and has developed a system and method of synthesizing the animation of an entire model using part animations, rather than merely connecting part animations (e.g., the upper and lower halves of the body).

### SUMMARY OF THE INVENTION

Accordingly, it is an object of the present invention to provide an animation generating technique wherein various types of animation can be readily generated.

One aspect of the present invention is to perform control animation of mutually-related parts by specifying the importance of each of the parts making up the model to the overall animation. Also, an animation synthesizing technique is used to synthesize and generate the animation in real-time. The invention also includes a method for specifying the range of effects each part may have, by indicating the importance of each part of the model, to the over all animation.

Further, animation synthesizing is performed by executing interpolation processing for multiple sets of basic animation to generate a new animation. This interpolation processing may be linear or non-linear interpolation. For example, the animation synthesizing method disclosed in Japanese Unexamined Patent Application Publication No. 2000-11199 titled “Automatic animation generating method,” assigned to the Assignee of the present application, and the teaching of which is incorporated herein by reference, may be employed.

According to the present invention, more animation expressions can be realized by dividing the animation into separate animations for each of the parts making up the model. Also, the relationships between the various part animations can be stipulated so that more complex animation synthesizing can be realized as compared to synthesizing animation of the entire model. Moreover, the synthesizing can be performed in real-time, so that interactive animation expressions can be realized.

Now, according to one aspect of the present invention, an animation generating method is provided to realize the above described objects. The animation generating method includes a number of steps. A step is provided for storing animation data for the entirety of a model which is the object of animation. Another step is provided for storing animation data for a part of the model. A generating step generates new animation data for the part, using animation data for a part of the model and a part of animation data for the entirety of the animation data which corresponds to the part. Finally, in an exchanging step, the part of animation data for the entirety of the animation data which corresponds with the part is exchanged with the new animation data with this configuration, overall animation data is corrected as partial animation data, so the amount of processing is small, and detailed specifications can be made.

According to an embodiment of the invention, animation data can be provided as framework data (nodes) importance data can be provided to each node, to specify the degree of effect due to each partial animation.

Also, multiple partial animation data sets can be synthesized into one model. For example animation data for the right hand and animation data for the left hand can be simultaneously synthesized. The multiple partial animation data sets may relate to a common part. For example, animation data for the waist and animation data for the legs (including the waist) may be simultaneously synthesized.

Partial animation synthesizing may be based on events or like input entered by the user. With animation generation wherein data between key frames is interpolated from key frame data, there is no guarantee that key frames for the entire animation and key frames for partial animation will match, timing-wise. Entire animation data in the synthesizing timing is interpolated from key frames, and further, partial animation data in the same synthesizing timing is interpolated from key frames, and new animation data is generated at that timing using these data sets obtained by interpolation.

Note that the present invention is realized not only as a device or as a system, but also as a method. Portions of the present invention as such may be configured as software. Furthermore, the present invention also encompasses software products used for executing such software do a computer (i.e., recording media for storing the software and the like).

Additional features and advantages of the present invention are described in, and will be apparent from, the following Detailed Description of the Invention and the figures.

### BRIEF DESCRIPTION OF THE FIGURES

FIG. 1 is a system diagram illustrating an overall embodiment of the prevent invention;

FIG. 2 is a block diagram schematically illustrating the configuration of an embodiment of the animation synthesizing unit 10 shown in FIG. 1;

FIG. 3 is a flowchart describing the overall operation of the embodiment shown in FIG. 1;

FIG. 4 is a diagram describing an example of synthesizing performed by the system according to the embodiment shown in FIG. 1;

FIG. 5 is a diagram describing specification of importance values to various nodes according to an embodiment of the invention;

FIG. 6 is a diagram describing a framework model according to an embodiment of the invention;

FIG. 7 is a diagram describing a framework model of a partial animation according to an embodiment of the invention;

FIG. 8 is a diagram describing another example of specifying the importance values to various node according to an embodiment of the invention;

FIG. 9 is a timing diagram describing the passage of time during a synthesizing operation according to an embodiment of the invention;

FIGS. 10A through 10D are diagrams describing data structures for managing the passage of time as shown in FIG. 9; and

FIG. 11 is a diagram describing another synthesizing example according to the above embodiment.

### DETAILED DESCRIPTION OF THE INVENTION

According to an embodiment of the present invention, a device is provided for realizing the synthesizing of part animations. Further, a method according to the present invention in which part animations are synthesized with a foundation animation is also provided. The method will be described below with reference to an example of a scene of a figure raising its left hand. A description regarding the range of effects will be described as well.

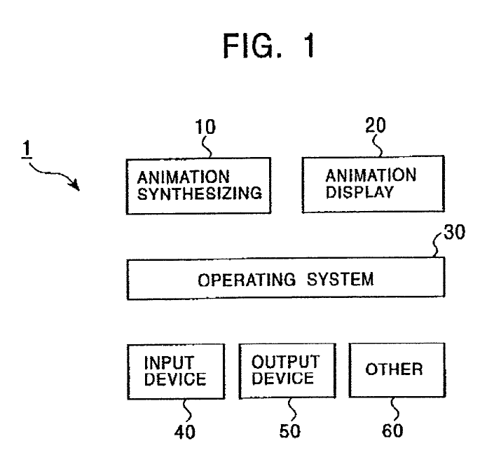

FIG. 1 illustrates an overall block diagram of an animation generating device according to an embodiment of the preset invention. The animation generating device 1 includes an animation synthesizing unit (application) 10, an animation display unit (application) 20, an operating system 30, an input device 40, an output device 50, and other resources such as hardware and software, and so forth. The animation generating device 1 may be mounted in a game apparatus, a personal computer, or the like, but may also be configured as an animation editing device as well. The operating system 30 depends on the environment where the device is mounted. Thus, the operating system may be a general-purpose operating system for a personal computer, or may be a built-in operating system for the device itself. The animation generating unit 10 synthesizes both the entire animation and the partial animations. The animation display unit 20 receives the animation data (data of the entire synthesized animation or data of the entire animation which is not synthesized) and generates image data, which is output to the output device (display) 50. The animation display unit 20 receives framework data from the animation synthesizing unit 10 for example, generates polygon data, and further performs rendering processing. Though not shown in the drawings, the rendering processing or the like may be carried out using dedicated hardware.

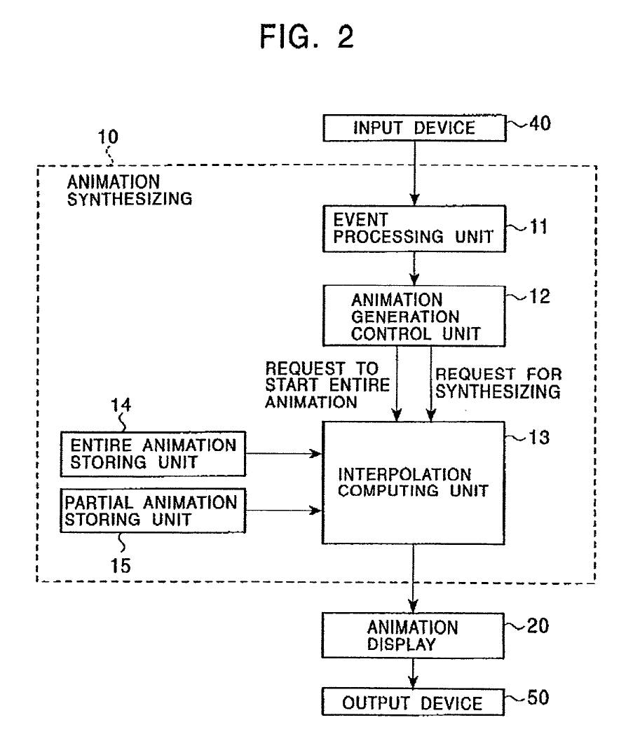

FIG. 2 schematically shows the configuration of the animation synthesizing unit 10 shown in FIG. 1. In this drawing, the components of animation synthesizing unit 10 include an event processing unit 11, animation generating control unit 12, an interpolation computing unit 13, an entire animation storing unit 14, and a partial animation storing unit 15. The event processing unit 11 redirects event information (key input or controller operation) input from the input device 40 to the animation generating control unit 12. The animation generating control unit 12 supplies entire animation start requests and partial animation synthesizing requests to the interpolation computing unit 13, based on predetermined animation progress information. The interpolation computing unit 13 extracts entire model animation data stored in the entire animation storing unit 14 and partial model animation data stared in the partial animation storing unit 15 according to these requests, and performs interpolation computations thereon, thereby generating new animation data, which is supplied to the animation display unit 20. Animation generation proceeds based on a clock (not shown). The animation display unit 20 generates image data based on the animation data, and outputs this to the output device 50.

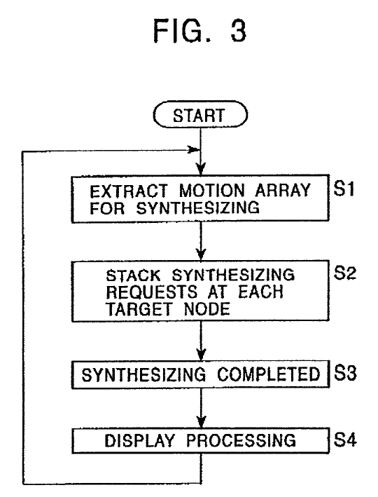

FIG. 3 illustrates the operation of the animation synthesizing unit 10 shown in FIG. 2. As shown in this drawing, a motion array for stipulating the entire motion (entire animation) is extracted for synthesizing in step S1. Further, at step S2 synthesizing requests are stacked for each synthesizing target part. Next, in step S3 synthesizing processing is executed, and results are subsequently displayed in step S4. The above processing is continually repeated.

Next, the present embodiment will be described in further detail with reference to the example of synthesizing the partial animation of raising the left hand.

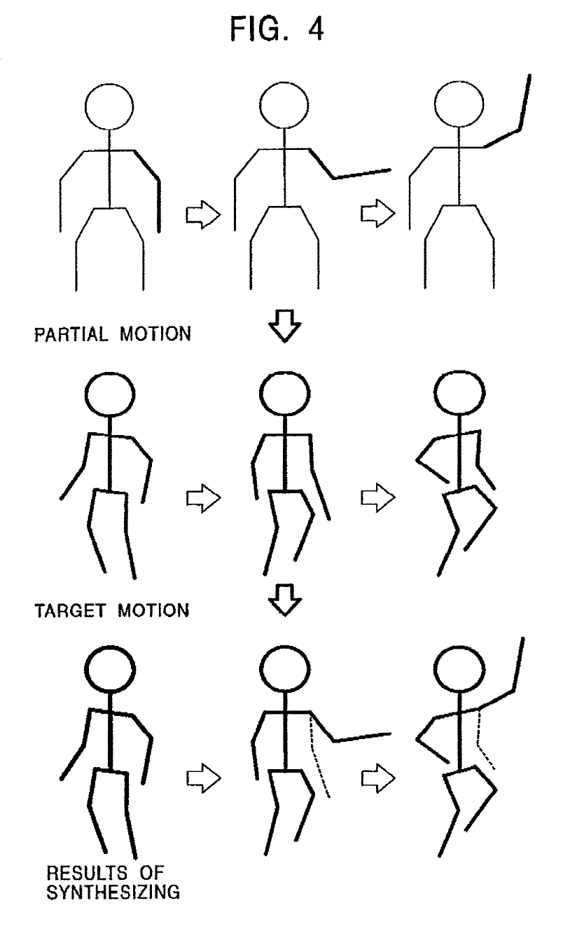

FIG. 4 illustrates the manner in which the partial animation of raising the left hand is synthesized. In this view, the model is shown facing outward from the page, facing in the direction of a person viewing the drawing. The partial motion of the left arm is such that the left arm is raised gradually. The entire animation (target motion) includes motion of slightly wavering to the left and right. The synthesizing results are the partial motion synthesized with the target motion. In this example, it can be understood that the left arm part is affected by the partial animation as to the object action and changes.

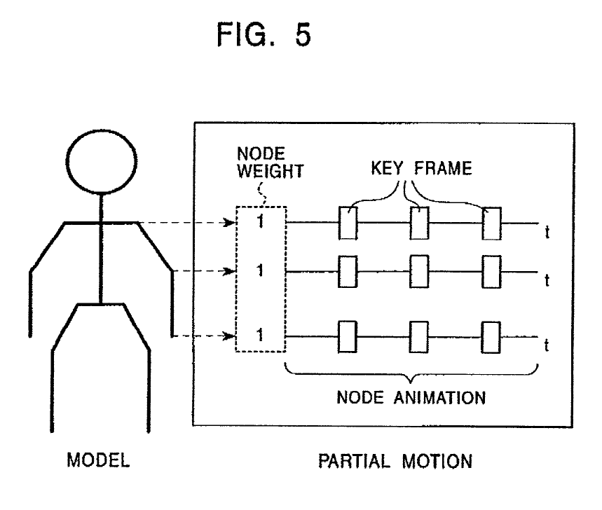

FIG. 5 illustrates a method for specifying a part which has an effect on the partial animation. In this example, the importance in the partial animation is specified as weight. Specifically, the shoulder, elbow, and hand nodes are given importance of 1. The sum of the importance (weight) of the partial animation and the importance (weight) of the entire animation is 1. In this example, the importance of the shoulder, elbow, and hand nodes of the entire animation is zero, so only the partial animation data is used for the shoulder, elbow, and hand nodes. The angle of the joints to be synthesized can be reflected in the partial animation by weighting and adding these. In the importance specification of the partial animation, the parts which are not zero are competing parts. This is realized by performing weighted addition at competing parts at the point of activating the partial animation, with the weight w specified in the partial animation and the weight “1−w” of the movement currently displayed.

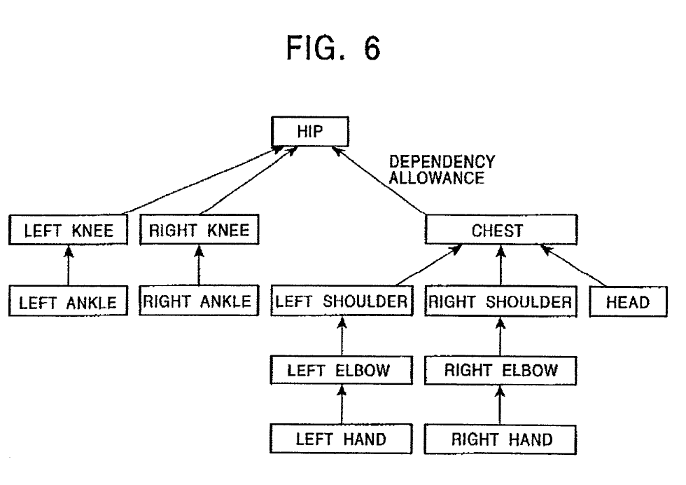

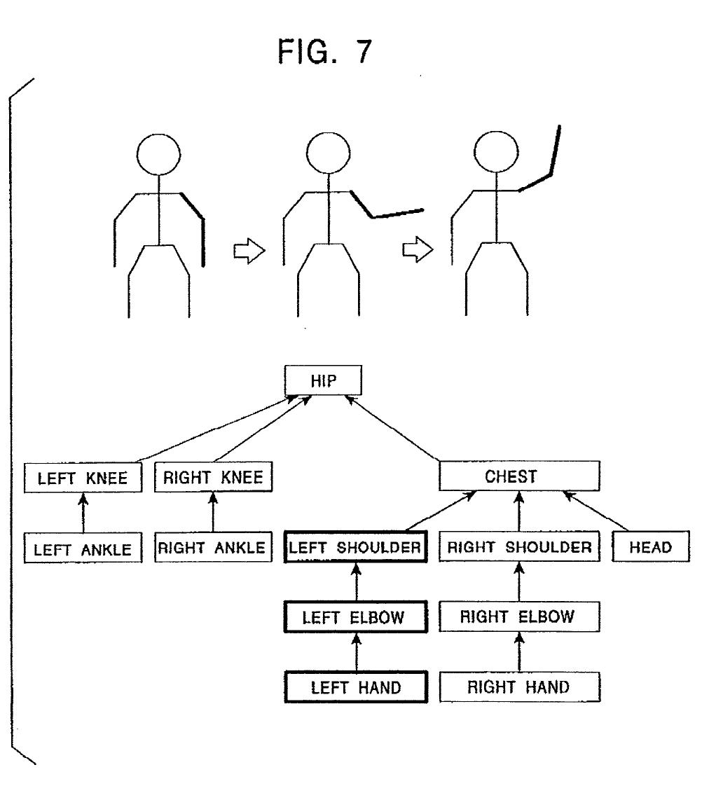

FIG. 6 illustrates an example of the overall movement described in the framework model. FIG. 7 illustrates an example of movement of a part (left arm). The movement of this part generates the animation of raising the left arm, as shown at the upper portion of FIG. 7.

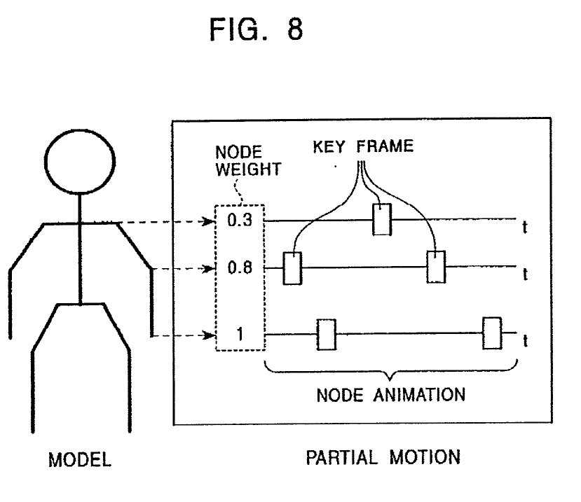

The importance (weight) shown in FIG. 5 can be independently specified for each node. In the example in FIG. 8, the importance of the shoulder is set at “0.3”, the importance of the elbow at “0.8”, and the importance of the hand at “0.811. In this example, the closer to the shoulder the part is, the less effect there is. Also, in this example, the key frame timing is off for each node. Even in the event that the key frames are off, interpolation and generation of synthesizing timing data for each is performed from the key frame data, and the results are used for synthesizing with the entire animation data.

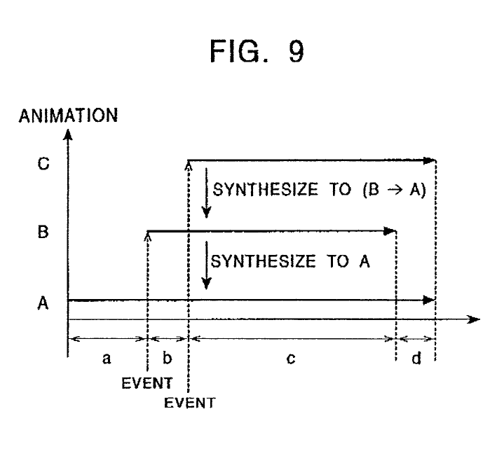

FIG. 9 illustrates the manner in which animation synthesizing is performed in multiplex. In section “all, animation A is being activated. In section “b”, animation B is added to this, creating a motion (B-A). In section “c”, animation C is added to this. In section ”d, , , animation B ends and animation C is added to animation A.

As can be seen with animation g, there a modes wherein synthesizing is ended at the time of ending the animation, and modes wherein synthesizing is continued at the final state of the animation. Further, specifications can be made to repeat the animation, as with “waving the hand”.

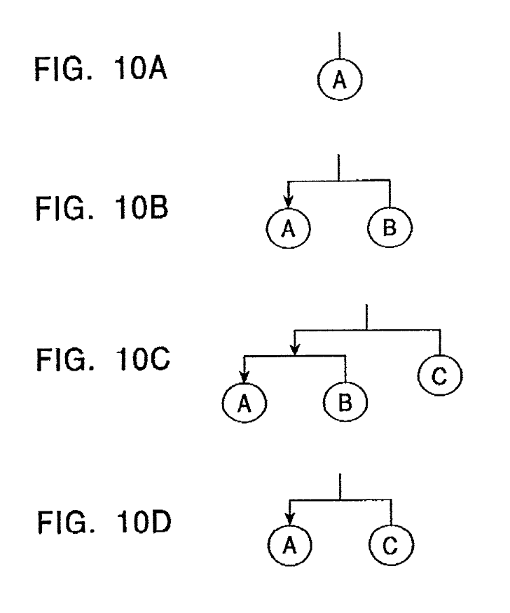

In FIGS. 10A through 10D a tree structure is used to represent the partial animation and the object of the synthesizing. In section a in FIG. 9, animation A is executed, and ma shown in FIG. 10A, there is one element. In section b, n is synthesized with A, so the structure is that shown in FIG. 10B. In section c, c is synthesized with that shown in FIG. 108, so the structure is that shown in FIG. 10C. At section d wherein the animation B has ended, the structure changes, as shown in FIG. 10D. Thus, the synthesizing results can be managed.

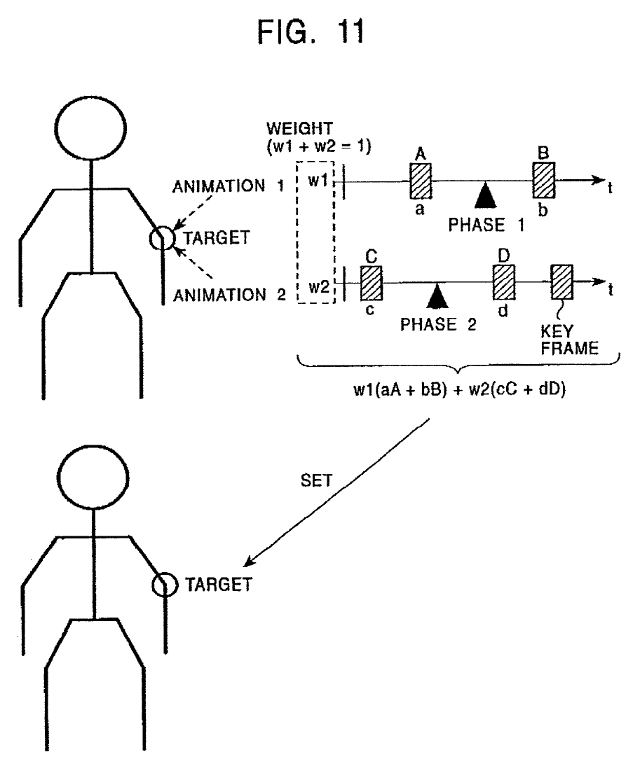

FIG. 11 illustrates the manner in which two partial animations (elbow) are synthesized with the entire animation. In this example, the importance of the partial animation 1 is w1, and the importance of the partial animation 2 is w2. Following interpolation at the key frames (with interpolation coefficients a, b, c, and d), weighed addition is performed with w1 and w2, and further this is stacked to the target and synthesized with the entire model.

Of course, three or more partial animations may be used, as well. As described above, according to the present invention, model animation can be generated by synthesizing animations of the parts making up a model. Further, animation synthesizing can be performed in real-time, so this can be used in interactive animation generation as well. Accordingly, the effectiveness of animation production can be markedly improved, and production can be performed with the same manner of work for real-time animation generation as with non-real-time animation generation.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. An animation generating method, comprising the steps of:
storing animation data for the entirety of a model which is the object of animation;
storing animation data for a part of said model;
generating new animation data for said part, using the animation data for said part of said model and a part of the animation data for said entirety of said animation data which corresponds with said part; and
exchanging said part of said animation data for said entirety of said animation data which corresponds with said part, with said new animation data.

2. An animation generating method according to claim 1, wherein said part of said model is not continuous in said model.

3. An animation generating method according to claim 2, wherein a plurality of sets of animation data fox said part of said model are synthesized regarding said animation data for the entirety of said model.

4. An animation generating method according to claim 3, wherein said plurality of sets of animation data for said part of said model that are synthesized contain animation data for a common part of said model.

5. An animation generating method according to claim 2, wherein said animation data for said part of said model specifies a synthesizing state of each part of said part by a level of importance which indicates the degree of effect of said data for said part.

6. An animation generating method according to claim 2, wherein parts of said model include, but are not limited to, a surface making up said mode, control points for generating said surface, and a model framework.

7. An animation generating method according to claim 2, wherein animation data for a part of said model is synthesized with said entire animation data, according to synthesizing events.

8. An animation generating method according to claim 7, wherein synthesizing is performed between:
said entire animation data obtained by generating, by interpolation from key frame data, said entire animation data, for each display cycle, generating, by interpolation, from key frame, said animation data for said model part, for each display cycle and interpolating; and
animation data for said part of said model obtained by interpolation;
thereby enabling synthesizing to be performed even in the event that the key frame timing for said entire animation data and the animation data key frame timing for said part of said model, are off.

9. An animation generating device, comprising:
entire animation storing means for storing animation data for the entirety of a model which is the object of animation;
part animation storing means for storing animation data for a part of said model;
means for generating new animation data for said part, using animation data fox a part of said model and a part of animation data for the entirety of said animation data which corresponds with said part; and
means for exchanging said part of animation data for the entirety of said animation data which corresponds with said part, with said new animation data.

10. An animation generating device according to claim 9, wherein said part of said model is not continuous in said model.

11. An animation generating device according to claim 10, wherein a plurality of sets of animation data for said part of said model are synthesized regarding said animation data for the entirety of said model.

12. An animation generating device according to claim 11, wherein said plurality of sets of animation data for said part of said model that are synthesized contain animation data for a common part of said model.

13. An animation generating device according to claim 10, wherein said animation data for said part of said model specifies a synthesizing state of each part of said part by level of importance which indicates the degree of effect of said data for said part.

14. An animation generating device according to claim 10, wherein parts of amid model include, but are not limited to, a surface making up said model, control points for generating said surface, and a model framework.

15. An animation generating device according to claim 10, wherein animation data for a part of said model is synthesized with said entire animation data, according to synthesizing events.

16. An animation generating device according to claim 15, wherein synthesizing is performed between:
said entire animation data obtained by generating, by interpolation from key frame data, said entire animation data, for each display cycle, generating, by interpolation from key frame, said animation data for said model part, for each display cycle, and interpolating; and
animation data for said part of said model obtained by interpolation;
thereby enabling synthesizing to be performed even in the event that the key frame timing for said entire animation data and the animation data key frame timing for said part of said model, are off.

17. A computer-readable recording medium fox recording a computer program for causing a computer to execute the steps of:
storing animation data for the entirety of a model which is the object of animation;
storing animation data for a part of said model;
generating new animation data for said part, using the animation data for said part of said model and a part of the animation data for said entirety of said animation data which corresponds with said part: and
exchanging said part of said animation data for said entirety of said animation data which corresponds with said part, with said new animation data.

18. A computer-readable recording medium according to claim 17, wherein said part of said model is not continuous in said model.

19. A computer-readable recording medium according to claim 18, wherein a plurality of sets of animation data for said part of said model are synthesized regarding said animation data for the entirety of said model.

20. A computer-readable recording medium according to claim 19, wherein said plurality of sets of animation data for said part of said model that are synthesized contain animation data for a common part of said model.

21. A computer-readable recording medium according to claim 18, wherein said animation data for said part of said model specifies a synthesizing state of each part of said part by a level of importance which indicates the degree of effect of said data for said part.

22. A computer-readable recording medium according to claim 18, wherein parts of said model include, but are not limited to, a surface making up said model, control points for generating said surface, and a model framework.

23. A computer-readable recording medium according to claim 18, wherein animation data for a part of said model. is synthesized with said entire animation data, according to synthesizing events.

24. A computer-readable recording medium according to claim 23, wherein synthesizing is performed between:
said entire animation data obtained by generating, by interpolation from key frame data, said entire animation data, for each display cycle, generating, by interpolation from key frame, said animation data for said model part, for each display cycle, and interpolating; and
animation data for said part of said model obtained by interpolation;
thereby enabling synthesizing to be performed even in the event that the key frame timing for said entire animation data and the animation data key frame timing for said part of said model, are off.

25. An animation generating method comprising the steps of:
preparing animation for a part of a model which is the object of animation;
generating animation, and
synthesizing a specified, currently-executed animation therewith, thereby generating a new animation.

26. An animation generating method according to claim 25, wherein said part of said model is not continuous in said object model.

27. An animation generating method according to claim 26, wherein a plurality of sets of animation data for said part of said model are synthesized regarding said animation data for the entirety of said model.

28. An animation generating method according to claim 27, wherein said plurality of sets of animation data for said part of said model that are synthesized contain animation data for a common part of said model.

29. An animation generating method according to claim 26, wherein said animation data for said part of said model specifies a synthesizing state of each part of said part by level of importance which indicates the degree of effect of said data.

30. An animation generating method according to claim 26, wherein parts of said model include, but are not limited to, a surface making up said model, control points for generating said surface, and a model framework.

31. An animation generating method according to claim 26, wherein animation data for a part of said model is synthesized with said entire animation data, according to synthesizing events.

32. An animation generating method according to claim 31, wherein synthesizing is performed between said entire animation data obtained by:
generating, by interpolation from key frame data, said entire animation data, for each display cycle, generating, by interpolation from key frame, said animation data for said model part, for each display cycle, and interpolating; and
animation data for said part of said model obtained by interpolation;
thereby enabling synthesizing to be performed even in the event that the key frame timing for said entire animation data and the animation data key frame timing for said part of said model, are off.
